(19) United States
(12) Patent Application Publication
(10) Pub. No.: US 2008/0117004 A1
(43) Pub. Date: May 22, 2008

(54) HIGH-FREQUENCY FILTER HAVING ELECTROMAGNETICALLY-COUPLED BRANCH LINES

(75) Inventor: Satoshi MOCHIZUKI, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: Yokogawa Electric Corporation, Tokyo (JP)

(21) Appl. No.: 11/942,327

(22) Filed: Nov. 19, 2007

(30) Foreign Application Priority Data
Nov. 21, 2006 (JP) 2006-314099

(51) Int. Cl. H01P 1/203

(52) U.S. Cl. 333/204

(57) ABSTRACT

A high-frequency filter for cutting off a specific frequency element of a high-frequency signal, includes a transmission line for transmitting the high-frequency signal; and a plurality of branch lines, formed in a direction which intersects the transmission line, having a coupling part at which the branch lines are electromagnetically coupled with each other. Typically, one or more pairs of the adjacent branch lines are provided, wherein the branch lines are electromagnetically coupled in each pair; and the coupling part is provided on the middle or head of the branch lines. Preferably, each branch line has: a first pattern, whose width is smaller than that of the transmission line, and which functions as an inductance element with respect to the high-frequency signal; and a second pattern, whose width is larger than that of the first pattern, and which forms the coupling part.

### BACKGROUND OF THE INVENTION

1. Field of the Invention

The present invention relates to a high-frequency filter for cutting off a specific frequency element of a high-frequency signal

Priority is claimed on Japanese Patent Application No. 2006-314099, filed Nov. 21, 2006, the content of which is incorporated herein by reference.

2. Description of the Related Art

FIG. 10 is a plan view showing the structure of a distributed-constant low-pass filter 100, which is generally known. Here, the low-pass filter 100 in FIG. 10 may be formed by using micro strip lines. As shown by FIG. 10, between an input line 101 and an output line 102 of the conventional low-pass filter 100, an open stub 103, a pattern 104, an open stub 105, a pattern 106, and an open stub 107 are formed in this order from the input-line (101) side.

The open stubs 103, 105, and 107 are branch lines formed in a direction which intersects the transmission line for a high-frequency signal, which is laid from the input line 101 to the output line 102. Each open stub functions as a capacitance element (i.e., capacitor) with respect to a high-frequency signal. The patterns 104 and 106 are lines, which are narrower than the input line 101 and the output line 102, and extend in a direction from the input line 101 toward the output line 102. These patterns function as inductance elements with respect to a high-frequency signal.

In the above structure, a high-frequency signal, input from the input line 101, passes through the open stub 103, the pattern 104, the open stub 105, the pattern 106, and the open stub 107 one after another. Through this passage, a high-frequency element included in the high-frequency signal is cut off. Accordingly, only a low-frequency element included in the high-frequency signal can pass through the low-pass filter 100, and is output from the output line 102. In addition, the low-pass filter 100 in FIG. 10 is a five-order low-pass filter.

FIG. 11 is a graph showing the transmission characteristics of ordinary low-pass filters, and shows a curve L10 with respect to transmission characteristics of a Chebyshev filter, and a curve L20 with respect to transmission characteristics of a Butterworth filter. As shown by FIG. 11, the transmission characteristics of the Chebyshev filter have (i) a ripple Δr which appears within a passing frequency range, and (ii) a larger attenuation gradient in the vicinity of the cut-off frequency fc in comparison with the Butterworth filter. In contrast, the transmission characteristics of the Butterworth filter have (i) a smaller attenuation gradient (i.e., a gentler attenuation) in comparison with the Chebyshev filter, and (ii) a flat transmission characteristic within a passing frequency range. The attenuation gradient of the Butterworth filter in FIG. 11 is −6 dB/oct, that is, when the frequency is doubled, an attenuation of −6 dB occurs. Details with regard to conventional filtering circuits may be shown in Japanese Unexamined Patent Application, First Publication No. H6-97701.

In recent years, downsizing is required for various kinds of electronic parts. For example, with respect to a cellular phone which uses a high-frequency signal, small size and small weight are essentially required, and thus such a request for downsizing is also imposed on a high-frequency filter used in cellular phones. When the high-frequency filter is designed using an ordinary Chebyshev or Butterworth filter as described above, the size of the product can be considerably evaluated based on design specifications. However, if downsizing is required, a substrate having a large dielectric constant must be used.

In addition, a steep attenuation characteristic is often required for high-frequency filters. However, in order to provide such a characteristic, several orders (of the filter) are required, which increases the filter size, and a substrate having a large dielectric constant must be used. When using such a substrate having a large dielectric constant, impedance mismatching may occur between the filter and a circuit which is formed on another substrate, or the pattern width may be extremely small. Such problems may cause difficulty in manufacturing. In addition, substrates having a large dielectric constant are expensive, which increases the manufacturing cost. Furthermore, using an additional (i.e., separate) substrate for only the high-frequency filter is unpreferable in consideration of mounting of parts.

### SUMMARY OF THE INVENTION

In light of the above circumstances, an object of the present invention is to provide a small-sized high-frequency filter, which has a steep attenuation characteristic and can be manufactured at a low cost, without using a substrate having a large dielectric constant.

Therefore, the present invention provides a high-frequency filter (see reference numerals 11, 12, 21, 22, 31, and 32 in the drawings) for cutting off a specific frequency element of a high-frequency signal, comprising:

a transmission line (see reference numerals 10, 20, 30, 40, and 50 in the drawings) for transmitting the high-frequency signal; and

a plurality of branch lines (see reference numerals 13 and 14 in the drawings), formed in a direction which intersects the transmission line, having a coupling part (see reference numerals 13b and 14b in the drawings) at which the branch lines are electromagnetically coupled with each other.

In accordance with the present invention, a part of a high-frequency signal input into the transmission line is transmitted through a branch line, which is formed in a direction which intersects the transmission line, and further transmitted through another branch line via the coupling part, so as to return to the transmission line.

Typically, one or more pairs of the adjacent branch lines are provided, wherein the branch lines are electromagnetically coupled in each pair.

Also typically, the coupling part is provided on the middle or head of the branch lines.

Preferably, each branch line has:

a first pattern (see reference numerals 13a and 14a in the drawings), whose width is smaller than that of the transmission line, and which functions as an inductance element with respect to the high-frequency signal; and

a second pattern (see reference numerals 13b and 14b in the drawings), whose width is larger than that of the first pattern, and which forms the coupling part.

In this case, the first pattern and second pattern may each extend in the direction which intersects the transmission line.

The high-frequency filter may further comprise a second branch line (see reference numeral 15 in the drawings), provided on the middle of the transmission line, at a position corresponding to the above branch line.

In a typical example, the second branch line is U-shaped.

In a preferable example:

the transmission line and the branch lines are formed on a dielectric substrate (see reference symbol SB); and

the interval of the adjacent branch lines which form the coupling part is smaller than or equal to three times as much as the thickness of the dielectric substrate.

Preferably, in order to provide large electromagnetic coupling between the adjacent branch lines, the interval of the branch lines is smaller than or equal to the thickness of the dielectric substrate.

### BRIEF DESCRIPTION OF THE DRAWINGS

FIG. 1 is a plan view showing the structure of a high-frequency filter as a first embodiment in accordance with the present invention.

FIG. 2 is a sectional view along line A-A in FIG. 1.

FIG. 3 is a graph showing the reflection and transmission characteristics of the high-frequency filter in the first embodiment.

FIG. 4 is a plan view showing the structure of a high-frequency filter as a second embodiment in accordance with the present invention.

FIGS. 5A and 5B are graphs showing the reflection and transmission characteristics of the high-frequency filter in the second embodiment, where FIG. 5A shows the transmission characteristics, and FIG. 5B shows the reflection characteristics.

FIGS. 6A and 6B are plan views for comparing the sizes of a high-frequency filter as an embodiment in accordance with the present invention and a conventional high-frequency filter, where FIG. 6A is a plan view of a conventional high-frequency filter, and FIG. 6B is a plan view of a high-frequency filter as an embodiment of the present invention.

FIGS. 7A to 7D are graphs showing the reflection and transmission characteristics of the high-frequency filter in FIG. 6B and the conventional high-frequency filter in FIG. 6A, where FIG. 7A shows the transmission characteristics, FIG. 7B is an enlarged diagram of FIG. 7A, FIG. 7C shows the reflection characteristics, and FIG. 7D is a graph showing the group delay frequency characteristics.

FIG. 8 is a plan view showing a first variation of the high-frequency filter in accordance with the second embodiment of the present invention.

FIG. 9 is a plan view showing a second variation of the high-frequency filter in accordance with the second embodiment.

FIG. 10 is a plan view showing the structure of a distributed-constant low-pass filter, which is generally known.

FIG. 11 is a graph showing the transmission characteristics of ordinary low-pass filters.

### DETAILED DESCRIPTION OF THE INVENTION

Hereinafter, embodiments in accordance with the present invention will be described with reference to the appended figures.

### First Embodiment

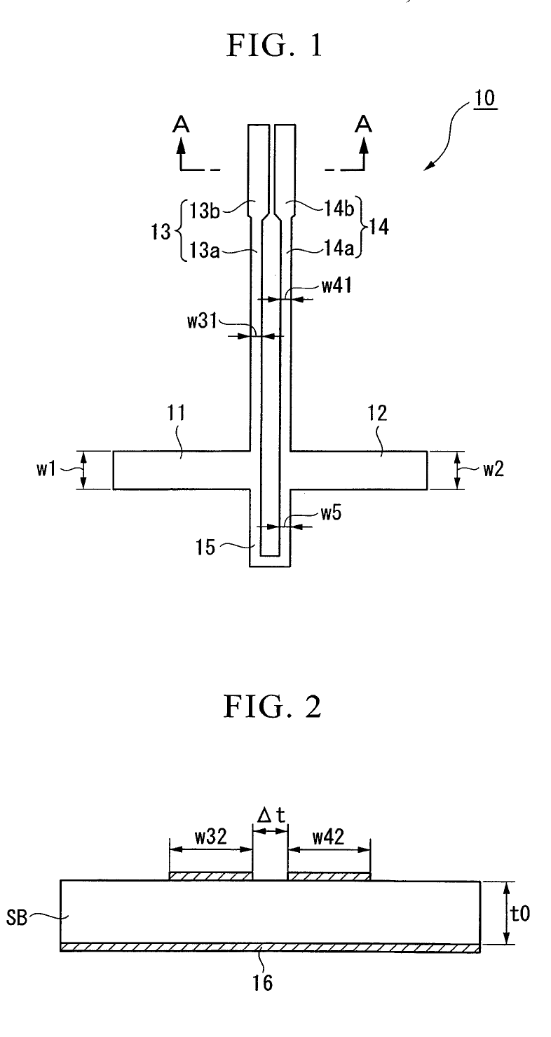

FIG. 1 is a plan view showing the structure of a high-frequency filter as a first embodiment of the present invention. FIG. 2 is a sectional view along line A-A in FIG. 1. The present high-frequency filter is formed by using micro strip lines.

As shown in FIG. 1, between an input line 11 and an output line 12 in a high-frequency signal transmission line of the high-frequency filter 10, branch lines 13, 14, and 15 are formed, where the line 15 corresponds to the second branch line of the present invention. The high-frequency filter 10 in FIG. 1 has a symmetrical form when observed from the input line 11 and from the output line 12.

A high-frequency signal is input into the input line 11, and a signal, obtained by cutting off or filtering out a specific frequency element from the high-frequency signal (input from the input line 11), is output from the output line 12. The widths w1 and w2 of the input line 11 and the output line 12 may be designed so as to provide a characteristic impedance of 50Ω. As the high-frequency filter 10 in FIG. 1 has a symmetrical circuit form, the widths w1 and w2 of the input line 11 and the output line 12 are the same, and are approximately 1 mm. Additionally, the input line 11 and the output line 12 are not directly connected, and are electrically connected with each other via the branch lines 13, 14, and 15.

The branch line 13 is connected to the input line 11, and extends in a direction which intersects the high-frequency signal transmission line from the input line 11 to the output line 12. In the following explanations, the direction from the input line 11 to the output line 12 is called a “transmission direction”, and the direction which intersects the transmission direction is called an “intersecting direction”.

The branch line 13 consists of a first pattern 13a and a second pattern 13b, which extend in the intersecting direction. The width w31 of the first pattern 13a is smaller than the width w1 of the input line 11 and also the width w2 of the output line 12, and the first pattern 13a functions as an inductance element with respect to a high-frequency signal. The width w32 of the second pattern 13b is larger than the width w31 of the first pattern 13a, and the second pattern 13b functions as an inductance element and also an open stub with respect to a high-frequency signal. The inductance element of the second pattern 13b differs from that of the first pattern 13a.

The branch line 14 is connected to the out line 12, and extends in the intersecting direction. Similar to the branch line 13, the branch line 14 consists of a first pattern 14a and a second pattern 14b, which extend in the intersecting direction. The width w41 of the first pattern 14a is smaller than the width w1 of the input line 11 and also the width w2 of the output line 12, and the first pattern 14a functions as an inductance element with respect to a high-frequency signal. The width w42 of the second pattern 14b is larger than the width w41 of the first pattern 14a, and the second pattern 14b functions as an inductance element and also an open stub with respect to a high-frequency signal.

As the high-frequency filter 10 in FIG. 1 has a symmetrical circuit form, the inductance element of the first pattern 14a is identical to that of the first pattern 13a of the branch line 13, and the inductance element of the second pattern 14b is identical to that of the second pattern 13b of the branch line 13.

The second pattern 13b of the branch line 13 and the second pattern 14b of the branch line 14 form a coupling part where the branch lines 13 and 14 are electromagnetically coupled with each other. That is, although the branch lines 13 and 14 are separate from each other as shown in FIG. 1, when a high-frequency signal, transmitted through the branch line 13, reaches the second pattern 13b thereof, a part of the signal element is transmitted to the branch line 14 via the second pattern 14b thereof Here, in the “electromagnetically coupled” state of the branch lines 13 and 14, the gap Δt between the branch lines 13 and 14 (i.e., the gap between the second patterns 13b and 14b) is smaller than or equal to three times as much as the thickness t0 of a dielectric substrate SB (see FIG. 2). On the back face of the dielectric substrate SB, a ground pattern 16 is formed, which is set as the earth electric potential.

When designing a high-frequency circuit in which the gap between relevant patterns is electromagnetically insulated, the gap is experientially made larger than three times the thickness t0 of a dielectric substrate SB. For example, in the case in which the thickness t0 of the dielectric substrate SB is 0.5 mm, when the gap between the relevant patterns is larger than 1.5 mm, transmission of a high-frequency signal between the patterns can be disregarded. In contrast, when the gap between the relevant patterns is smaller than or equal to three times as much as the thickness t0 of the dielectric substrate SB, transmission of a high-frequency signal between the patterns cannot be disregarded, and thus the patterns are electromagnetically coupled. Therefore, when the gap Δt between the branch lines 13 and 14 is smaller than or equal to three times as much as the thickness t0 of the dielectric substrate SB, the branch lines 13 and 14 are electromagnetically coupled with each other. However, in order to increase a coupling coefficient k, which indicates the degree of electromagnetic coupling between the branch lines 13 and 14, it is preferable to set the gap Δt between the branch lines 13 and 14 (i.e., the gap between the second patterns 13b and 14b) to be smaller than or equal to the thickness t0 of the dielectric substrate SB.

The above-described coupling part for electromagnetically coupling the branch lines 13 and 14 is provided for increasing the Q value of the filter. That is, as the branch lines 13 and 14, and also the branch line 15, in the high-frequency filter 10 of FIG. 1 function as inductance elements (more accurately, inductance elements and capacitance elements), a filter circuit is established without the coupling part, and thus a Q value is present. In addition to this, in the present embodiment, the branch lines 13 and 14 are electromagnetically coupled so as to generate a resonance. Therefore, the above Q value and the generated resonance produce a multiplier effect for increasing the Q value and providing a steep attenuation characteristic.

The branch line 15 is a U-shaped line, which is connected to the input line 11 and the output line 12. The width w5 of the branch line 15 is smaller than the width w1 of the input line 11 and also the width w2 of the output line 12, and the branch line 15 functions as an inductance element with respect to a high-frequency signal.

The dielectric substrate SB on which the high-frequency filter 10 is formed is a generally-available, low-priced substrate, such as a glass-epoxy substrate. The size in the transmission direction of the branch lines 13 to 15 is a few millimeters, and the size in the intersecting direction of them is approximately a dozen millimeters.

In the above structure, a high-frequency signal input from the input line 11 is divided into (i) a signal transmitted through the branch line 13, which is connected to the input line 11, and (ii) a signal transmitted through the branch line 15, which is also connected to the input line 11. One of the divided signals reaches the second pattern 13b of the branch line 13 via the first pattern 13a thereof, and a part of the signal is transmitted to the second pattern 14b of the branch line 14, which is electromagnetically coupled with the second pattern 13b. The transmitted signal is supplied via the second pattern 14b and the first pattern 14a of the branch line 14 to the output line 12. On the other hand, the other divided signal is supplied via the U-shaped branch line 15 to the output line 12. The signal, which has passed through the branch lines 13 and 14, and the signal, which has passed through the branch line 15, are synthesized at the output line 12, and the synthesized signal is output from the output line 12.

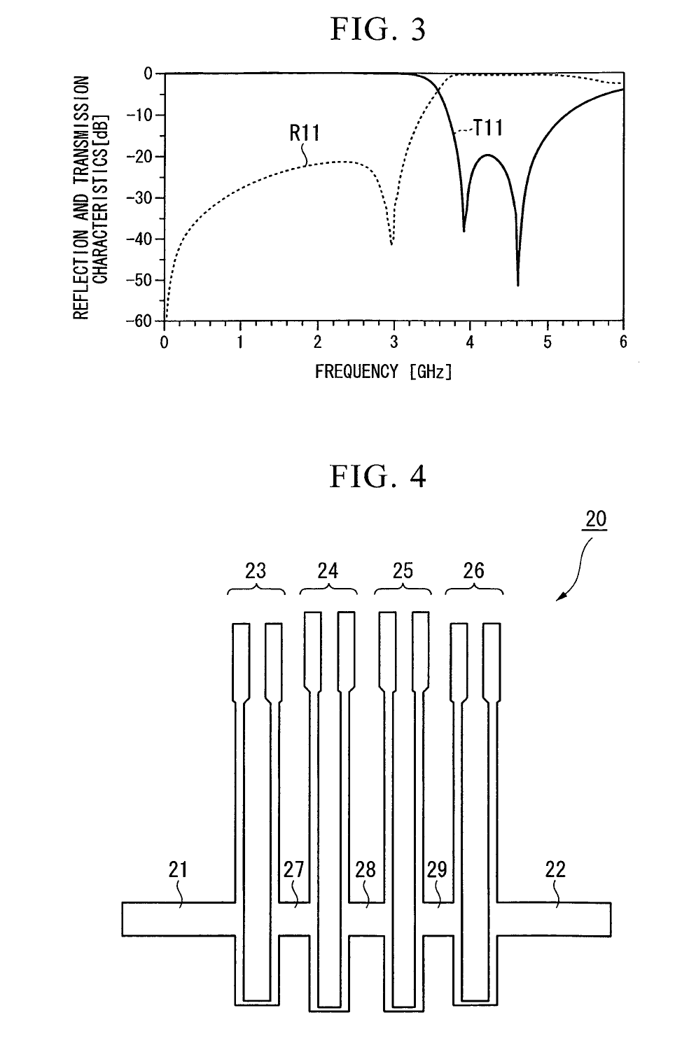

FIG. 3 is a graph showing the reflection and transmission characteristics of the high-frequency filter in the first embodiment. In FIG. 3, a curve indicated by reference symbol R11 shows reflection characteristics of the high-frequency filter 10, and a curve indicated by reference symbol T11 shows transmission characteristics of the high-frequency filter 10. More accurately, the curve R11 shows frequency characteristics of dispersion parameters S11 and S12 (i.e., S parameters) when the high-frequency filter 10 is regarded as a four-terminal circuit, and the curve T11 shows frequency characteristics of a dispersion parameters S21 with respect to the four-terminal circuit. Generally, with regard to the four-terminal circuit, S11 indicates input return loss, and shows input impedance matching; S22 indicates output return loss, and shows output impedance matching; and S21 indicates transmission characteristics, and shows signal transmission efficiency from the input terminal to the output terminal.

As shown in FIG. 3, in the vicinity of 3 GHz (frequency), as the frequency increases, the amount of reflection abruptly increases while the amount of transmission begins to decrease. Additionally, in the vicinity of 3.4 to 4 GHz, the transmittance abruptly decreases. Therefore, the high-frequency filter 10 of FIG. 1 has transmission characteristics of a low-pass filter. In addition, with reference to the curve T11 having the above feature in the vicinity of 3.4 to 4 GHz, the high-frequency filter 10 has a large attenuation gradient and thus has a steep attenuation characteristic. Accordingly, the high-frequency filter 10 as shown in FIG. 1 in the first embodiment is small-sized, can be manufactured at low cost, without using a substrate having a large dielectric constant. and also has a steep attenuation characteristic.

### Second Embodiment

FIG. 4 is a plan view showing the structure of a high-frequency filter as a second embodiment of the present invention. As shown in FIG. 4, a high-frequency filter 20 of the present embodiment is formed by connecting a plurality of high-frequency filters 10 as shown in FIG. 1, side by side. That is, between an input line 21 and an output line 22 of a transmission line for a high-frequency signal, filter parts 23 to 26 are provided, each of which has a branch-line structure similar to the branch lines 13 to 15 in FIG. 1. The filter parts 23 and 24 are connected via a connection line 27, the filter parts 24 and 25 are connected via a connection line 28, and the filter parts 25 and 26 are connected via a connection line 29.

In FIG. 4, with respect to the transmission line for a high-frequency signal, a totality of eight branch lines, which correspond to the branch lines 13 and 14 in FIG. 1, and a totality of four branch lines, which correspond to the branch line 15 in FIG. 1, are formed. In the above eight branch lines corresponding to the branch lines 13 and 14, each pair of adjacent branch lines are electromagnetically coupled, that is, each of the filter parts 23 to 26 functions as a unit of coupling.

The filter parts 23 to 26 do not have the same form. The filter parts 24 and 25 are slightly longer than the filter parts 23 and 26 in the intersecting direction. In addition, the high-frequency filter 20 in FIG. 4 also has a symmetrical form when observed from the input line 21 and from the output line 22, and is formed on a low-priced substrate such as a glass epoxy substrate, similar to the dielectric substrate SB shown in FIG. 2.

In the following explanation, the high-frequency filter 20 has a symmetrical-form circuit. However, it may have an asymmetrical-form circuit, and the filter parts 23 to 26 may have different coupling coefficients from each other. Also in the following explanation, each pair of the branch lines, provided in the filter parts 23 to 26, electromagnetic coupling occurs only within the relevant filter part. However, electromagnetic coupling may occur between adjacent filter parts. That is, the interval between the filter parts 23 to 26 may be smaller so as to produce electromagnetic coupling between the filter parts 23 to 26. In the high-frequency filter 20 of FIG. 4, the size in the transmission direction of the filter parts 23 to 26 is approximately ten millimeters, and the size in the intersecting direction of them is approximately a dozen millimeters.

In the above structure, a high-frequency signal input from the input line 21 is divided into (i) a signal transmitted through the pair of branch lines included in the filter part 23, which correspond to the branch lines 13 and 14 in FIG. 1, and (ii) a signal transmitted through the branch line, also included in the filter part 23, which corresponds to the branch line 15 in FIG. 1. One of the divided signal reaches the connection line 27 via the coupling part of the pair of the branch lines. The other of the divided signals reaches the connection line 27 via the U-shaped branch line. The signal, which passed through the pair of the branch lines, and the signal, which has passed through the other branch line, are synthesized at the connection line 27. A similar operation is sequentially performed at “the filter part 24 and the connection line 28”, “the filter part 25 and the connection line 29”, and “the filter part 26 and the output line 22”, and the signal, which has experienced filtering, is output from the output line 22.

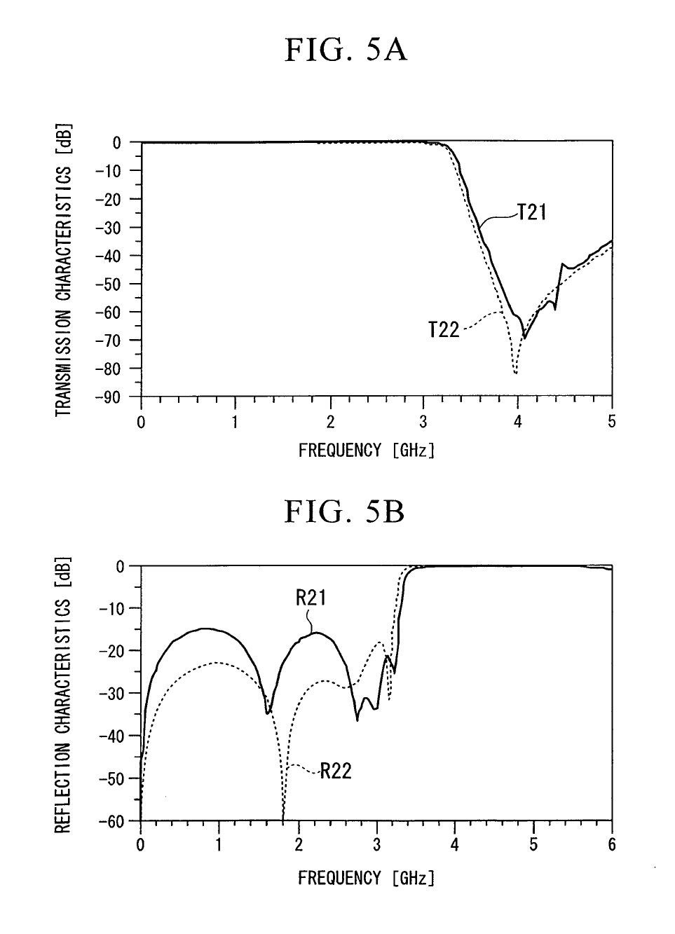

FIGS. 5A and 5B are graphs showing the reflection and transmission characteristics of the high-frequency filter 20 in the second embodiment. FIG. 5A shows the transmission characteristics, and FIG. 5B shows the reflection characteristics.

In FIG. 5A, a curve indicated by the reference symbol T21 shows actually-measured values with respect to the transmission characteristics of the high-frequency filter 20, and a curve indicated by the reference symbol T22 shows simulated results with respect to the transmission characteristics of the high-frequency filter 20. In FIG. 5B, a curve indicated by the reference symbol R21 shows actually-measured values with respect to the reflection characteristics of the high-frequency filter 20, and a curve indicated by the reference symbol R22 shows simulated results with respect to the reflection characteristics of the high-frequency filter 20. More accurately, the curves T21 and T22 show the frequency characteristics of the dispersion parameter S21 (i.e., S parameter) when the high-frequency filter 20 is regarded as a four-terminal circuit, and the curves R21 and R22 show frequency characteristics of the dispersion parameters S11 and S22 with respect to the four-terminal circuit.

As shown in FIG. 5A, in the vicinity of 3 GHz (frequency), as the frequency increases, the amount of transmission decreases almost linearly and abruptly. On the other hand, as shown in FIG. 5B, as the frequency increases from approximately 3 GHz, the amount of reflection abruptly increases, and almost all of the incident high-frequency signal is reflected in the vicinity of 3.6 GHz. In addition, as shown by FIGS. 5A and 5B, the high-frequency filter 20 in FIG. 4 has the transmission characteristics of a low-pass filter, and the actually-measured values almost coincide with the simulated results. Furthermore, when being compared with FIG. 3, the amount of transmission at frequencies of 4 to 5 GHz is smaller in FIG. 5A. Accordingly, the high-frequency filter 20 as shown in FIG. 4 in the second embodiment is small, can be manufactured at a low cost, without using a substrate having a large dielectric constant, and also has steep attenuation characteristics. In addition, the transmittance in a high-frequency band (of 4 to 5 GHz) is smaller than that in the first embodiment, thereby producing desirable transmission characteristics.

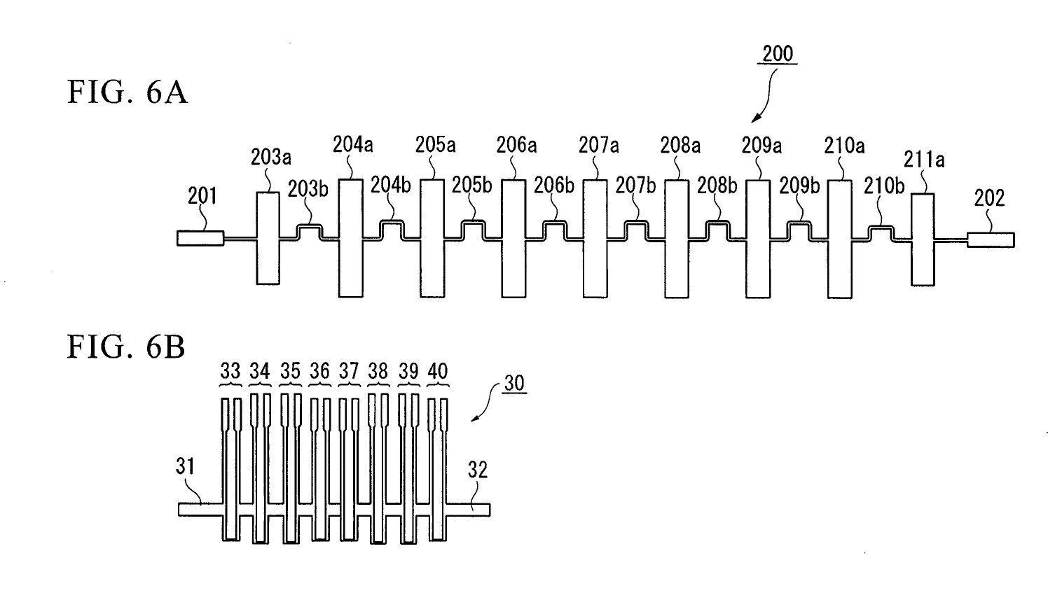

FIGS. 6A and 6B are plan views for comparing the sizes of a high-frequency filter as an embodiment in accordance with the present invention and a conventional high-frequency filter. FIG. 6A is a plan view of a conventional high-frequency filter, and FIG. 6B is a plan view of a high-frequency filter as an embodiment of the present invention.

A conventional high-frequency filter 200 in FIG. 6A is formed by using micro strip lines, and has open stubs 203a to 211a and patterns 203b to 210b between an input line 201 and an output line 202.

The open stubs 203a to 211a are wide branch lines, extending in a direction which intersects a high-frequency signal transmission line from the input line 201 and the output line 202. The open stubs 203a to 211a function as capacitance elements (i.e., capacitors) with respect to a high-frequency signal. The patterns 203b to 210b each have (i) a width smaller than each width of the input line 201 and the output line 202, and (i) a U-shaped form, and function as inductance elements with respect to a high-frequency signal.

In contrast, a high-frequency filter 30 as an embodiment of the present invention, as shown in FIG. 6B, has a form obtained by connecting two high-frequency filters 20 side by side. That is, between an input line 31 and an output line 32 of a transmission line for a high-frequency signal, filter parts 33 to 40 are provided, each of which has a structure similar to the branch lines 13 to 15 shown in FIG. 1. The filter parts 33 to 40 are connected to each other via connection lines.

The conventional high-frequency filter 200 of FIG. 6A and the high-frequency filter 30 as the embodiment of the present invention are each formed on a dielectric substrate having an identical dielectric constant.

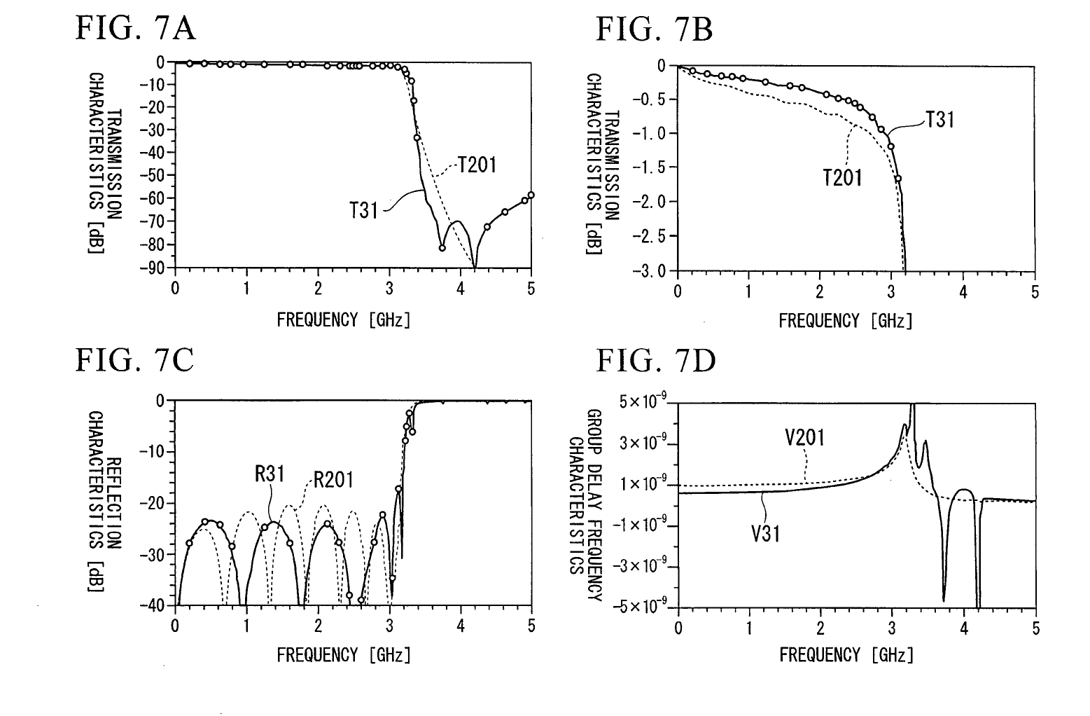

FIGS. 7A to 7D are graphs showing the reflection and transmission characteristics of the present high-frequency filter 30 and the conventional high-frequency filter 200. FIG. 7A shows the transmission characteristics, FIG. 7B is an enlarged diagram of FIG. 7A (only the scale of the vertical axis is enlarged), FIG. 7C shows the reflection characteristics, and FIG. 7D is a graph showing group delay frequency characteristics.

In FIGS. 7A and 7B, a curve indicated by the reference symbol T31 shows actually-measured values with respect to the transmission characteristics of the present high-frequency filter 30, and a curve indicated by the reference symbol T201 shows the transmission characteristics of the conventional high-frequency filter 200. In FIG. 7C, a curve indicated by the reference symbol R31 shows actually-measured values with respect to the reflection characteristics of the present high-frequency filter 30, and a curve indicated by the reference symbol R201 shows reflection characteristics of the conventional high-frequency filter 200.

In FIG. 7D, a curve indicated by the reference symbol V31 shows group delay frequency characteristics of the present high-frequency filter 30, and a curve indicated by the reference symbol V201 shows group delay frequency characteristics of the conventional high-frequency filter 200.

With reference to FIGS. 7A to 7D, it is understood that the reflection and transmission characteristics and group delay frequency characteristics of the present high-frequency filter 30 are substantially identical to those of the conventional high-frequency filter 200.

Both the present high-frequency filter 30 shown in FIG. 6A and the conventional high-frequency filter 200 shown in FIG. 6B occupy approximately a dozen millimeters in the intersecting direction, and the sizes thereof make no great difference in that direction. However, in comparison that the size of the conventional high-frequency filter 200 in the transmission direction is approximately 65 mm, the size of the present high-frequency filter 30 in the transmission direction is approximately 20 mm, that is, smaller than one third the size of the conventional high-frequency filter 200. Therefore, Although the high-frequency filter 30 as an embodiment of the present invention has similar reflection and transmission characteristics to those of the conventional high-frequency filter 200, it can be small in comparison with the conventional high-frequency filter 200.

### Other Embodiments

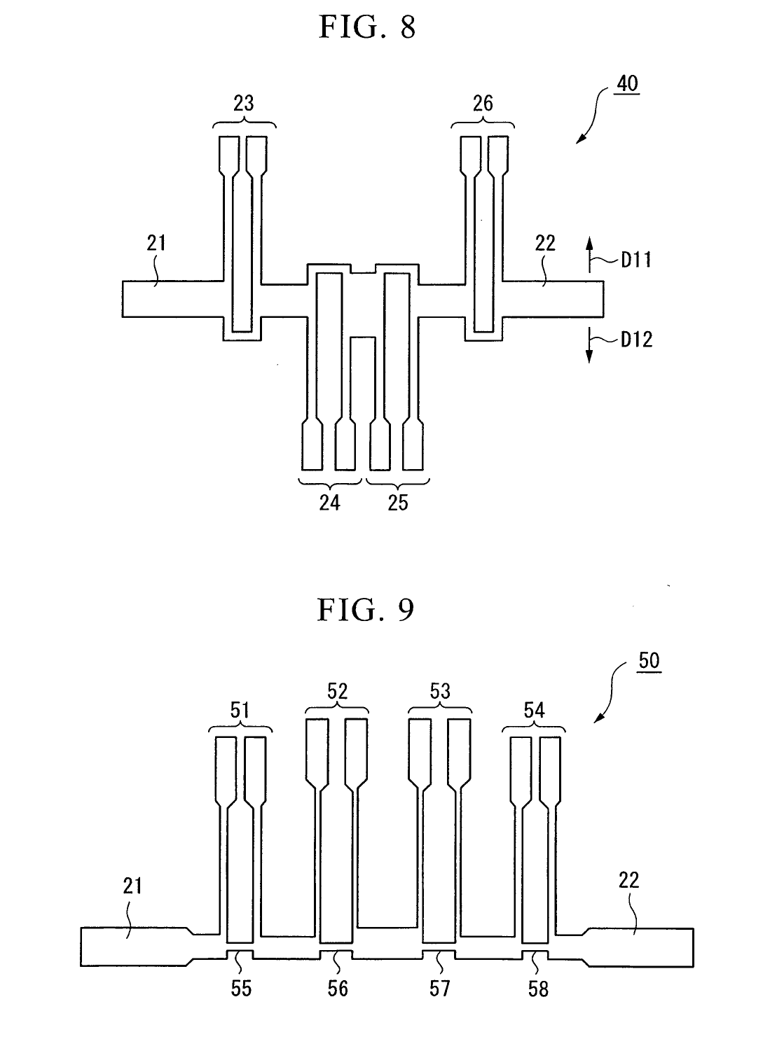

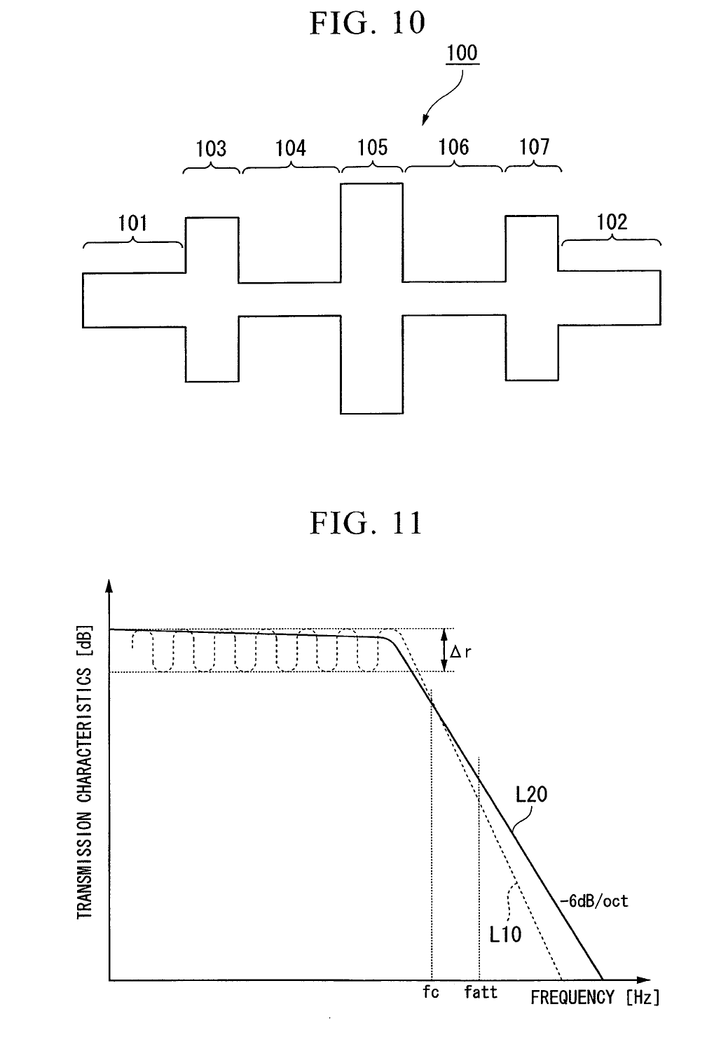

FIG. 8 is a plan view showing a first variation of the high-frequency filter in accordance with the second embodiment of the present invention. In the filter parts 23 to 26 of the high-frequency filter 20 in FIG. 4, the branch lines corresponding to the branch lines 13 to 14 in FIG. 1 are arranged on one side with respect to the high-frequency signal transmission line, and the other branch lines corresponding to the branch line 15 in FIG. 1 are arranged on the other side with respect to the high-frequency signal transmission line.

However, as shown in FIG. 8, the branch line arrangement in the filter parts 23 to 26 may be modified. For example, in filter parts 23 and 26 of a high-frequency filter 40 of FIG. 8, the branch lines corresponding to the branch lines 13 to 14 in FIG. 1 are arranged in a direction indicated by the reference symbol D11 with respect to the high-frequency signal transmission line, and the other branch lines corresponding to the branch line 15 in FIG. 1 are arranged in a direction indicated by the reference symbol D12 with respect to the high-frequency signal transmission line. In contrast, in filter parts 24 and 25 of the high-frequency filter 40, the branch lines corresponding to the branch lines 13 to 14 in FIG. 1 are arranged in the direction indicated by the reference symbol D12 with respect to the high-frequency signal transmission line, and the other branch lines corresponding to the branch line 15 in FIG. 1 are arranged in the direction indicated by the reference symbol D11 with respect to the high-frequency signal transmission line. As described above, arrangement of the branch lines may be appropriately modified.

FIG. 9 is a plan view showing a second variation of the high-frequency filter in accordance with the second embodiment of the present invention. In the filter parts 23 to 26 of the high-frequency filter 20 in FIG. 4, the branch lines corresponding to the branch line 15 in FIG. 1 are each U-shaped. However, the form of each branch line corresponding to the branch line 15 is not limited to the U-shape, and may be linear.

A high-frequency filter 50 in FIG. 9 has filter parts 51 to 54 between an input line 21 and an output line 22 of a transmission line with respect to a high-frequency signal. The filter part 51 has (i) branch lines corresponding to the branch lines 13 and 14 in FIG. 1, and (ii) a linear branch line 55. Similarly, each of the filter parts 52 to 54 has (i) branch lines corresponding to the branch lines 13 and 14 in FIG. 1, and (ii) a linear branch line (i.e., relevant one of branch lines 56 to 58).

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

In the above-described high-frequency filter 10 of the first embodiment, the second patterns 13b and 14b are formed as a coupling part on the head of the branch lines 13 and 14. However, the coupling part may be formed on the middle of the branch lines 13 and 14. In addition, the second branch lines 13b and 14b as the coupling part are respectively wider than the first patterns 13a and 14a. However, the widths of the second branch lines 13b and 14b may be respectively identical to those of the first patterns 13a and 14a, and the interval between the second branch lines 13b and 14b may be smaller than the interval between first patterns 13a and 14a, so as to electromagnetically couple the branch lines 13 and 14 with each other. The above modifications can be also applied to the second embodiment and the variations thereof.

Also in the above-described embodiments, the high-frequency filters are formed using micro strip lines. However, they may be formed by using embedded micro strip lines, asymmetric strip lines, or the like. In addition, the present invention is not limitedly applied to micro strip lines, but can be applied to waveguides, frequency selective surfaces (FSSs), or the like.

What is claimed is:

1. A high-frequency filter for cutting off a specific frequency element of a high-frequency signal, comprising:
a transmission line for transmitting the high-frequency signal; and
a plurality of branch lines, formed in a direction which intersects the transmission line, having a coupling part at which the branch lines are electromagnetically coupled with each other.

2. The high-frequency filter in accordance with claim 1, wherein one or more pairs of the adjacent branch lines are provided, wherein the branch lines are electromagnetically coupled in each pair.

3. The high-frequency filter in accordance with claim 1, wherein the coupling part is provided on the middle or head of the branch lines.

4. The high-frequency filter in accordance with claim 1, wherein each branch line has:
a first pattern, whose width is smaller than that of the transmission line, and which functions as an inductance element with respect to the high-frequency signal; and
a second pattern, whose width is larger than that of the first pattern, and which forms the coupling part.

5. The high-frequency filter in accordance with claim 4, wherein the first pattern and second pattern each extend in the direction which intersects the transmission line.

6. The high-frequency filter in accordance with claim 1, further comprising:
a second branch line, provided on the middle of the transmission line, at a position corresponding to the above branch line.

7. The high-frequency filter in accordance with claim 6, wherein the second branch line is U-shaped.

8. The high-frequency filter in accordance with claim 1, wherein:
the transmission line and the branch lines are formed on a dielectric substrate; and
the interval of the adjacent branch lines which form the coupling part is smaller than or equal to three times as much as the thickness of the dielectric substrate.
